(19) United States
(12) Patent Application Publication
(10) Pub. No.: US 2014/0215836 A1
(43) Pub. Date: Aug. 7, 2014

(54) DOUBLE SERRATED FORK

(71) Applicant: Dashamir Elezi, Durres (AL)

(72) Inventor: Dashamir Elezi, Durres (AL)

(21) Appl. No.: 14/240,906

(22) PCT Filed: Jun. 29, 2012
(86) PCT No.: PCT/AL2012/000001

§ 371 Date: Feb. 25, 2014

(30) Foreign Application Priority Data
Aug. 25, 2011 (AL) AL/P/2011/3817

(51) Int. Cl. A47J 43/28; A47G 21/02

(52) U.S. Cl. CPC A47J 43/283; A47G 21/023
USPC 30/322

(57) ABSTRACT

The title of the invention is “SG MAITREFORK”; the initials as defined by the inventor, while the word “MAITREFORK” contains in itself the purpose of this invention, which consists of a double serrated fork which is used in the gastronomic field and specifically in modern restaurants (kitchens) in which Maitre (Chief Hall) performs completion of cooking and preparation in the presence or in front of the client in the restaurant. Also, this invention finds its use in different gastronomic tables related to fast food (fast food, take way etc.)

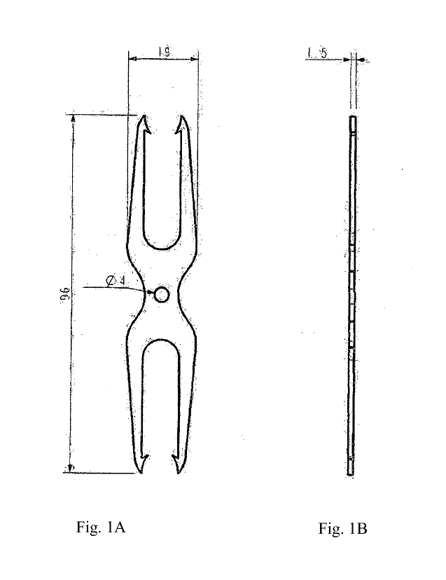

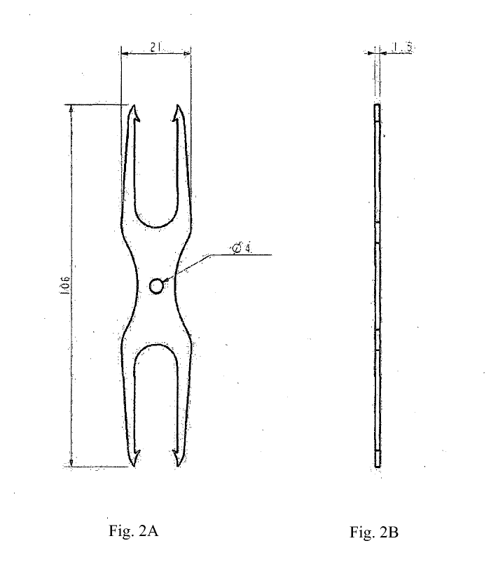

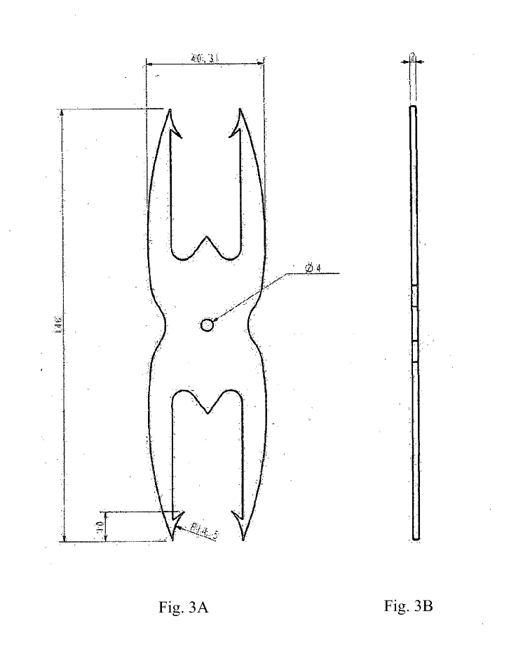

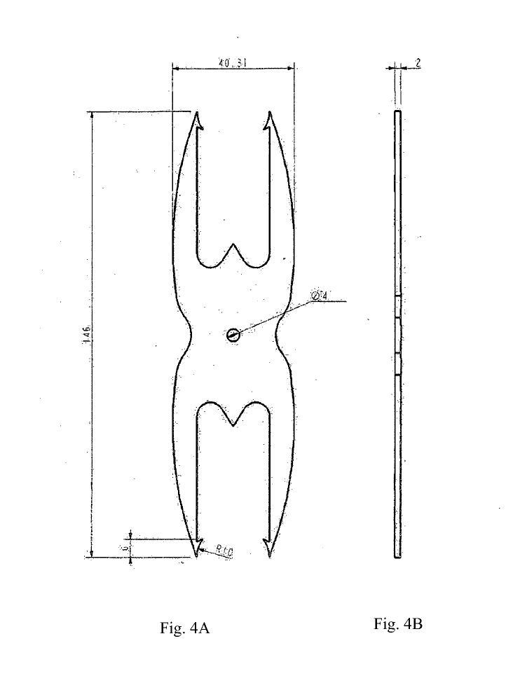

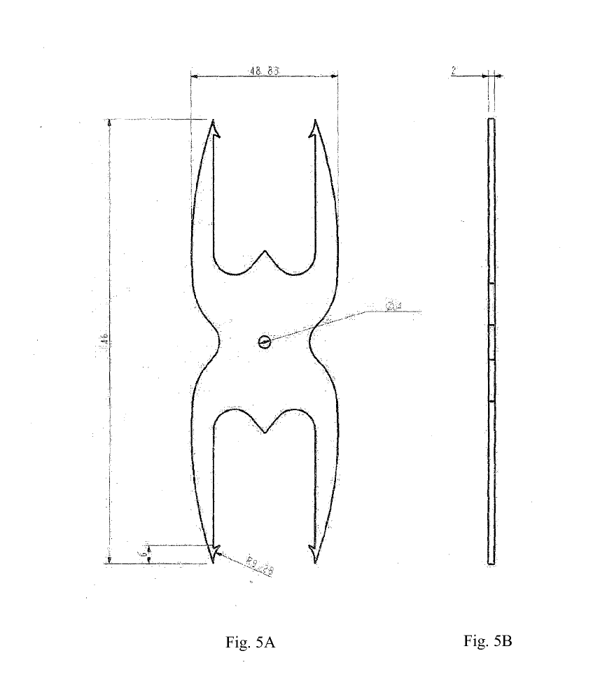

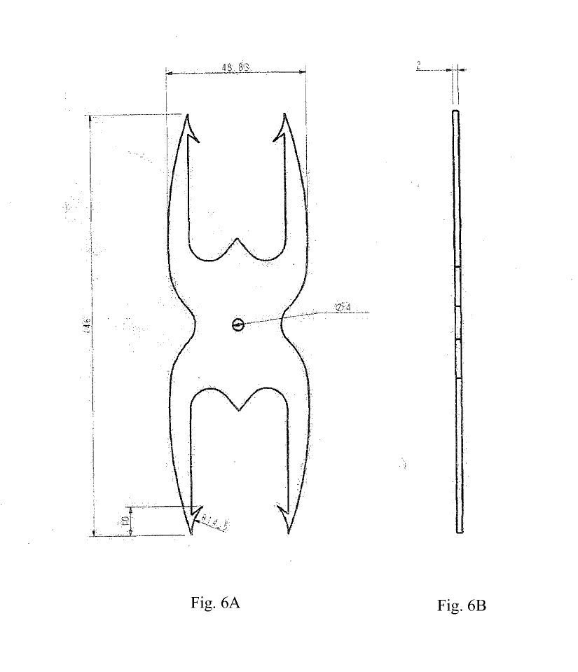

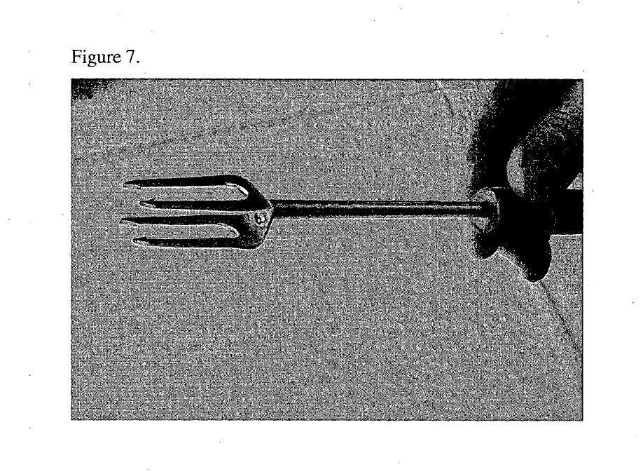

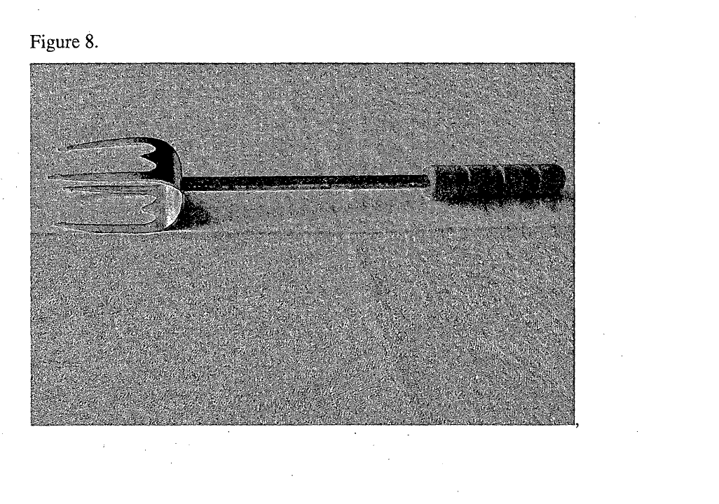

### TECHNICAL FIELD

The title of the invention is “SG MAITREFORK”; the initials as defined by the inventor, while the word “MAITREFORK” contains in itself the purpose of this invention, which consists of a double serrated fork which is used in the gastronomic field and specifically in modern restaurants (kitchens) in which Maitre (Chief Hall) performs completion of cooking and preparation in the presence or in front of the client in the restaurant. Also, this invention finds its use in different gastronomic tables related to fast food (fast food, take way etc.)

### BACKGROUND ART

Before this invention there was not any similar utensil for gastronomic use, through which the products could be processed without any supporting plane or plates, but instead, with the use of S G Maitrefork” utensil everything is accomplished while the product is anchored through the utensil, the product is not supported into an working plane or plate, with a very good stability and easily maneuvering the tool. Before, these processing were performed by supporting the gastronomic products on a table and using a gastronomic fork or pliers as a blocker (holding) element for the gastronomic product.

### DESCRIPTION

The invention consist in a serrated double fork with 2 by 2 teeth placed in two different plans; the projection of an upper device view, shows the teeth placed in the corners of a rectangle; it is used in the gastronomic field and specifically in the modern restaurants in which Maitre (the Chief Hall) performs completion of a cooking and/or entire preparation of a plate/dish in the presence or in front of the client present in the hall. Also, this invention finds use in different gastronomic feast related to fast food (fast food, take way).

The stability of the product, which will be processed (i.e, removal of the skin or product fragmentation) is obtained with this type of tool as the four tines of the utensil, as it can be seen from the respective drawings, are placed in a position that represents the four corners of the square, and are equipped with ratchet (blocker tines) which holds firmly the product to be handled, while maintaining its stability.

This utensil comes on different sizes for use in different situations with different food products. In this way it becomes possible not to damage the product during the cutting, cutting in a correct way, product saving and simplicity in the management, by performing the service in front of the client. While the methods used before have some disadvantages which are: non-proper stability, lack of accurate maneuverability with the gastronomic product, the lack of precision in cutting the gastronomic product and which often seems being not economically efficient.

1. An ergonomic utensil comprising four long ratchet (or not ratchet) tines, two by two positioned in parallel different planes, made of stainless food material according to international standards of this sector, jointed into a holding tail, which is fixed into an ending handle made of non-sliding material (plastic or stainless material according to international standards of this sector), creating efficient conditions for the stability of gastronomic and other food products, simple and comfortable rotation of food during the cutting/fragmentation phase.

2. The ergonomic utensil of claim 1 wherein the four long tines are ratchet (shaped in a ‘hook-form’) sized and positioned two by two in front of each-other allowing a perfect fixing of the food, preventing movement or displacement of food during the cutting, fragmentation or processing.

3. The ergonomic utensil of claim 1 wherein the handle is of a circular profile with a diameter ranging from 22-25 mm and height of 12 mm, made of porous material (wood or plastic specifically for use in the kitchen) in order to be fixed easily by the user and not being able to slide, allowing a simple and convenient rotation during food/product cutting in helicoidally shape or during product fragmentation as in the case of unpeeling a fruit item, or by cutting them to pieces while using the ergonomic utensil as anchoring tool, without touching the product by hand at all.

4. The ergonomic utensil of claim 3 wherein the handle is filled inside with a high specific weight material, in order to provide sustainability to the utensil during the performance, gadrooned, creating efficient conditions for the stability of gastronomic and other food products during the cutting/fragmentation phase,

5. The ergonomic utensil of claim 4 wherein the distance between the pairs of tines varies according to the dimensions/sizes of food to be treated, allowing this way a simple penetration of food without deteriorating or encountering obstacles in piercing (bone, cartilage, fibrous tissue, fibre, cores . . . ); similar the case of cleanly unpeeling a kiwi-fruit item (without interfering with wooden part in the fruit pole).

6. The ergonomic utensil of claim 5 wherein a smaller tine is between two ratchet tines, only on the larger size utensils, to provide a greater food support allowing an even greater sustainability.

7. The ergonomic utensil of claim 2 wherein tines are designed in an extended and linear form in order to favour penetration.

8. The ergonomic utensil of claim 7 wherein thickness and depth of tines are accomplished depending on the size of the food to be cut or fragmentized.

9. The ergonomic utensil of claim 8 wherein the length and width are is-in proportion to the food, creating a perfect balance of weight, while not allowing food to move during the cutting,

10. The ergonomic utensil of claim 9, wherein the utensils is specially adapted according to the food to be handled/processed, wherein the distance of the peaks of the ergonomic utensil from the handle favours control of food, avoiding contact that may arise from cutting mistakes.

11. The ergonomic utensil of claim 10 wherein the holding tail and the ending handle are 150-250 mm long, according to utensil size depending on appropriate weight balance of the processing/fragmented product to accomplish a sufficient stability,
